(19) United States
(12) Patent Application Publication
(10) Pub. No.: US 2023/0213205 A1
(43) Pub. Date: Jul. 6, 2023

(54) DOMESTIC APPLIANCE DEVICE

(71) Applicant: BSH Hausgeräte GmbH, Munich (DE)

(72) Inventors: Carlos Franco Gutierrez, Zaragoza (ES); Teresa Del Carmen Marzo Alvarez, Zaragoza (ES); Maria Parra Borderías, Zaragoza (ES)

(21) Appl. No.: 18/008,689

(22) PCT Filed: Jun. 16, 2021
(86) PCT No.: PCT/EP2021/066193

§ 371 Date: Dec. 7, 2022

(30) Foreign Application Priority Data
Jul. 1, 2020 (EP) 20382588.0

(51) Int. Cl. F24C 7/08; G06T 7/00

(52) U.S. Cl. CPC F24C 7/082; G06T 7/0002

(57) ABSTRACT

A household appliance apparatus includes a hyperspectral image capture unit configured to capture in an operating state a state of an object in an image capture region, and a control unit configured to ascertain an item of information in the operating state based on the state of the one object.

The invention relates to a household appliance apparatus, in particular a cooking appliance apparatus, as claimed in claim 1, a household appliance system having a household appliance apparatus as claimed in claim 11, a household appliance having a household appliance apparatus as claimed in claim 12 and a method for the operation of a household appliance apparatus as claimed in claim 13.

A household appliance apparatus having an optical sensor is already known from the prior art and the sensor is sensitive in relation to the visible electromagnetic spectrum and is provided so as to identify food.

The object of the invention is to provide in particular, but is not limited to, a household appliance apparatus of the generic type having improved characteristics with regard to comfort. The object is achieved in accordance with the invention by the features of claims 1 and 13 while advantageous embodiments and developments of the invention are apparent in the subordinate claims.

A household appliance apparatus, in particular a cooking appliance apparatus is proposed having at least one hyperspectral image capture unit that in at least one operating state is provided so as to capture a state, in particular an image, of at least one object in an image capture region, and having a control unit that is provided so as to ascertain at least one item of information in the operating state based on the state of the at least one object.

It is possible due to an embodiment of this type in particular to improve at least comfort, in particular user comfort. In particular, it is possible due to an embodiment of this type to ensure in particular a food preparation and namely in particular independent of ingredients that are used and/or storage processes of the ingredients that are performed and/or food compositions and/or possible replacement foods that are used, such as for example meat alternatives. In particular, it is possible to adapt on an individual basis, and in particular in an automated manner, independent of ingredients that are used and/or storage processes of the ingredients that are performed and/or possible replacement foods that are used, such as for example meat alternatives, in order to in particular ensure the recipe is followed. Furthermore, due to the embodiment in accordance with the invention it is rendered possible to identify and preferably to remove foreign bodies and/or spoiled food and/or damaged food and/or undesired food and/or contaminants and/or allergens. Moreover, advantageously comfort and/or reliability can be increased for a user since the household appliance apparatus provides that an object, in particular an item of food, and advantageously moreover an item that is not food related, can be captured in an automated manner. Moreover, in particular a reliability can be improved and namely at least with regard to a preparation and/or a storage of food. Furthermore, it is possible to improve safety, and namely in particular in relation to an ability to consume and to enjoy food since the information, and namely in particular visible and/or invisible information, can be ascertained in particular in a reliable manner. Moreover, it is possible to provide in particular improved characteristics at least with regard to comfort and/or reliability, and namely in particular with regard to a preparation of food. For example, due the embodiment in accordance with the invention alternatively or in addition improved characteristics could be achieved with regard to the storage of food and namely in particular in relation to a shelf life of food and/or an optimization of a storage duration of food.

The household appliance apparatus, in particular the cooking appliance apparatus, can be for example a part, in particular a sub assembly, of a household appliance, in particular a cooking appliance, and/or an accessory, in particular a household appliance accessory and/or a kitchen accessory. Alternatively or in addition, the household appliance apparatus could be designed as distributed, in particular structurally, to multiple household appliances. Alternatively, the household appliance apparatus could also comprise the entire household appliance.

For example, the household appliance, in particular the cooking appliance, could be designed as a hob, in particular as an induction hob. Alternatively or in addition, the household appliance that is designed in particular as a cooking appliance could have at least one oven and/or at least one microwave and/or at least one grilling appliance and/or at least one steam cooking appliance and/or could be designed as such. The oven could be for example a stove and/or an oven. Alternatively or in addition, the household appliance could have at least one refrigeration appliance and advantageously could be designed as a refrigeration appliance. The household appliance, in particular that is designed as a refrigeration appliance, could have for example at least one freezer and/or at least one freezer cabinet and/or at least one refrigerator and/or at least one upright freezer and/or at least one combination appliance and/or can be designed as such. The household appliance, in particular that is designed as a refrigeration appliance, could be provided for example so as to store and/or to preserve and/or to cool food and/or chilled goods, such as for example drinks and/or meat and/or fish and/or milk and/or milk products. For example, alternatively or in addition, the household appliance could have at least one cleaning appliance and can be designed in particular as a cleaning appliance. The household appliance, in particular that is designed as a cleaning appliance, could have for example at least one dryer and/or at least one washing machine and/or at least one dishwasher and/or can be designed as such. For example, the household appliance, in particular that is designed as a cleaning appliance, could be provided so as to clean for example dishware and/or laundry and/or a room and/or an item of furniture. Alternatively or in addition, the household appliance could be designed as an extractor hood and/or as a wall module.

A household appliance accessory is to be understood to mean an accessory that is provided in particular for usage and/or for use with a household appliance and/or that is designed in particular as at least one accessory part and/or as at least one set of accessory parts for a household appliance. A kitchen accessory is to be understood to mean an accessory that is provided for a usage and/or a use and/or for an arrangement in a kitchen, and namely in particular for processing and/or treatment and/or preservation of at least one item of food. For example, the household appliance apparatus, in particular the cooking appliance apparatus, could be part of a household appliance accessory. Alternatively, the household appliance apparatus could comprise the entire household appliance accessory.

A hyperspectral image capture unit is to be understood to mean a sensor unit that is provided so as in the operating state to capture a state, in particular an image, of an object in an image capture region by means of a hyperspectral recording. It is preferred that the hyperspectral image capture unit is designed as a hyperspectral camera. Advantageously, the hyperspectral image capture unit only comprises a single sensor element and in particular only a single lens and/or a single object lens. In particular, the hyperspectral image capture unit is provided so as to continuously record the hyperspectral recording. It is preferred that the hyperspectral image capture unit is provided so as to capture the state repeatedly and namely in particular with a scanning frequency of for example at least 0.1 scans per second, advantageously at least 0.5 scans per second, particularly advantageously at least one scan per second, preferably at least ten scans per second and particularly preferably one hundred scans per second.

A hyperspectral recording is to be understood as a recording, in particular an image capture, and namely a plurality of, in particular side by side wavelength part-ranges within an entire wavelength range that comprises a larger electromagnetic spectrum than the visible, in other words visible to humans, electromagnetic spectrum. The fact that the wavelength part-ranges are directly adjacent means that the wavelength ranges when viewed along the electromagnetic spectrum lie directly adjacent to one another. In particular, the plurality of wavelength part-ranges comprises a number of for example at least 25 wavelength part-ranges, advantageously at least 50 wavelength part-ranges, particularly advantageously at least 100 wavelength part-ranges, preferably at least 200 wavelength part-ranges and particularly preferably at least 400 wavelength part-ranges. In particular, a lower limit of the entire wavelength range of a wavelength of for example at least 100 nm, advantageously at least 200 nm, particularly advantageously at least 300 nm, preferably at least 380 nm and particularly preferably at least 400 nm. In particular, an upper limit of the entire wavelength range has a wavelength of for example at most 700 nm, advantageously at most 750 nm, particularly advantageously at most 800 nm, preferably at most 900 nm and particularly preferably at most 1000 nm. It is preferred that the hyperspectral image capture unit is provided so as to record the plurality of wavelength part-ranges within the entire wavelength range through a single lens and advantageously using a single sensor. An image capture region is to be understood to mean a region that can be captured by means of the hyperspectral image capture unit. In particular, the image capture region is a region that can be captured, in particular focused, by the hyperspectral image capture unit.

A control unit is to be understood to mean an electronic unit that is provided so as to evaluate data that is provided to the control unit and/or so as to control and/or feedback control at least one further unit based on data that is ascertained and/or provided. It is preferred that the control unit comprises a computing unit and, in particular in addition to the computing unit, a storage unit having a control program and/or feedback control program that is stored therein and the control program and/or feedback control program is provided so as to be executed by the computing unit. In particular, in the operating state the control unit ascertains at least one item of information based on the state of the at least one object. The fact that the control unit in the operating state “ascertains” at least one item of information is to be understood to mean that the control unit in the operating state determines at least one item of information by data processing. Alternatively or in addition, the control unit could be part of a household appliance system that has the household appliance apparatus. For example, the control unit could perform the data processing. Alternatively or in addition, the control unit could have a communication unit by means of which it is possible to transmit the state, in particular the image, to a cloud computing unit that performs the data processing and subsequently transmits the information back.

Provided is to be understood to mean specifically programmed, designed and/or equipped. The fact that an object is provided for a specific function is to be understood to mean that the object fulfils and/or executes this specific function in at least one application state and/or operating state.

Moreover, it is proposed that the hyperspectral image capture unit is provided so as to capture the state by means of a plurality of scanning values that in each case comprise an item of hyperspectral image information with regard to the at least one object. In particular, it is possible due to an embodiment of this type to increase comfort, in particular user comfort. In particular, the state can be captured by means of a high resolution, hyperspectral, image capture, which in particular improves accuracy. In particular, with respect to ascertaining the state with the aid of a scanning value, in particular a pixel, it is possible in particular to increase a reliability. In particular, due to an embodiment of this type it is possible moreover to increase safety in addition to the increased reliability. In particular, the hyperspectral image capture unit is provided so as to capture the state by means of a plurality of for example at least 1000 scanning values, advantageously at least 4000 scanning values, particularly advantageously at least 16 000 scanning values, preferably at least 300 000 scanning values and particularly preferably at least 2 000 000 scanning values. The scanning value is designed in particular as a pixel, in particular of a digital image. In particular, the plurality of scanning values is part of the hyperspectral recording. It is preferred that the hyperspectral image capture unit is provided so as to capture the state of the at least one object, which can be in particular a three-dimensional state, of a hyperspectral recording, wherein each pixel of the hyperspectral recording in each case comprises one item of hyperspectral image information with regard to the at least one object. For example, the plurality of scanning values, in particular the plurality of pixels, could be arranged in a lattice-like manner and advantageously in a grid-like manner.

Furthermore, it is proposed that the information comprises at least one item of food-related information. As a consequence, it is possible in particular to achieve a particularly high degree of comfort, in particular a particularly high degree of user comfort. Moreover, as a consequence, it is possible to achieve in particular a high degree of safety. Advantageously, it is possible to achieve a high degree of reliability, in particular with regard to ascertaining all food components. In particular, by means of the food information a conclusion could be drawn on a degree of ripeness, a degree of freshness, a type and/or ingredients of a food. For example, by means of the food information alternatively or in addition a conclusion could be drawn on at least one organoleptic characteristic of the food. It would be conceivable that the food information comprises for example at least one food composition. Alternatively or in addition, the food information could comprise for example at least one water content of the food and/or a fat content and/or a proportion of at least one further component of the food. Alternatively or in addition, the food information could render possible and/or comprise for example at least one conclusion on at least one structure and/or at least one texture of the food. Furthermore, it would be conceivable that the food information contains for example at least one item of information with regard to a food product. For example, the food information could comprise at least one identification of at least one food replacement product, such as for example meat replacement products or similar. Moreover, it would be conceivable that the food information comprises at least the allergens that are contained in the food, in particular a quantity and advantageously a location within the food of allergens that are contained in the food, such as for example nuts and/or gluten and/or soya and/or lactose and/or possible further potentially relevant allergens.

Moreover, it is proposed that the information comprises at least one item of information that is not food related. It is possible due to an embodiment of this type to achieve in particular a high degree of safety and namely in particular to achieve a high degree of food safety. In particular, it is possible due to an embodiment of this type to broaden the information. In particular, hypothetical actions can consequently be rendered possible. For example, the item of information that is not food related could comprise information with regard to an item of cookware and/or at least one cooking utensil. For example, by means of the item of information that is not food related a conclusion could be drawn on at least one impairment, for example damage, of the item of cookware and/or the at least one kitchen utensil. Alternatively or in addition, the at least one item of information that is not food related could render it possible to at least conclude the, in particular optical, state of at least one item of laundry. For example, the at least one item of information that is not food related comprises at least one item of information with regard to a soiling, for example of laundry. Alternatively or in addition, the at least one item of information that is not food related could comprise at least one item of information with regard to at least one soiling of at least a floor and namely in particular then if the household appliance apparatus is part of at least one cleaning appliance and/or at least one cleaning system.

Moreover, it is proposed that in the operating state, the control unit triggers at least one action based on the information. In particular comfort, and namely user comfort, can be increased due to an embodiment of this type. Moreover, in particular safety can be improved due to an embodiment of this type. Furthermore, in particular a cost for a user can be reduced due to an embodiment of this type. It is preferred that in the operating state, the control unit automatically triggers at least one action based on the information. In particular, it could be determined which action the control unit triggers, in particular automatically, due to the information and/or in particular due to the at least one object in the image capture region. For example, a plurality of actions could be possible, wherein the control unit selects and/or triggers, in particular automatically, at least one action of the plurality of actions in dependence upon the information.

Furthermore, it is proposed that the action comprises at least one output to a user. As a consequence, it is possible to achieve that the household appliance apparatus ensures improved characteristics with regard to comfort, in particular user comfort. In particular, it is consequently possible to improve at least a behavior with regard to a user feedback. In particular, the user can be accordingly informed, in particular in this respect by means of the output of information. Moreover, safety for the user can be improved due to an embodiment of this type. In particular, a reliable safety mechanism can be provided. For example, the output can be an output of the information. In particular, the output could be an output of the item of information that is not food related. Alternatively or in addition, the output is an output of the food information. In particular, the output could be an output of an item of information that is derived from the information. It would be conceivable that the output is performed for example by means of a loudspeaker and/or a buzzer and/or a display and/or a lighting means of the household appliance apparatus. For example, it would be conceivable that the household appliance apparatus outputs a sound and/or various sounds by means of a loudspeaker and/or a buzzer of the household appliance apparatus. Alternatively or in addition, it is conceivable that the output is an output in the form of an optical signal, for example with the aid of a light source of the household appliance apparatus, in particular by a blinking of an LED. Moreover, it is in particular conceivable that the output is a cable-bound and/or wireless signal transmission and namely in particular the information is output to at least one further unit. It is preferred that the output could be a cable-bound and/or wireless transmission of the information, in particular of the food information and/or the item of information that is not food related. Alternatively or in addition, it would be conceivable that the output is an output of the information by means of a display, advantageously a touch display, which is in particular part of the household appliance apparatus, part of a household appliance that has the household appliance apparatus or part of a household appliance system that has the household appliance apparatus. For example, the output could comprise a suggestion, in particular an indication, for the user. For example, the output could be a suggestion for the use of cookware. Alternatively or in addition, the output could be a suggestion to use and/or not use a lid when cooking.

Moreover, it is proposed that the output comprises a warning. As a consequence, it is possible to achieve that the household appliance apparatus provides improved safety for the user, in particular with regard to the food that is consumed by the user. Moreover, the household appliance apparatus can provide in particular improved safety with regard to non-foods that are used by the user. Moreover, it is possible due to an embodiment of this type to improve in particular comfort for the user. In particular, it would be conceivable that the control unit triggers the warning in the event of an impairment of the object. For example, the control unit could then trigger the output of the warning if for example at least one allergen is contained in the object, in particular in the food. For example, the control unit could trigger the output of the warning alternatively or in addition then if in particular at least one foreign body, for example packaging residue such as in particular transparent plastic and/or cooking waste material such as for example eggshell residue and/or nutshell residue and/or other foreign bodies such as for example sand and/or insects etc. is contained in the object, in particular in the food. Alternatively or in addition, the control unit could trigger the warning on account of pesticides or similar that are detected. Alternatively or in addition, the control unit could trigger the warning on account of a ripening state, for example on account of a ripening state that is too far advanced, of the object, in particular of the food. Alternatively or in addition, the control unit could trigger the warning on account of an item of spoiled food, and/or on account of mold that is contained in the food and/or heavy metal that is contained in the food. Alternatively or in addition, the control unit could then trigger the output of the warning if for example the non-food, in particular a surface, for example a surface of an item of cookware, has impairments. For example, the control unit could then trigger the output of the warning if the object has in particular impairments that are harmful, in particular harmful to the health of the user. As an example, however not limited thereto, is a damaged Teflon coating of a pan and/or a rusted pan. Alternatively or in addition, the control unit could trigger the warning if for example cookware that is used and/or other cooking utensils that are used by the user has or have undesired food residue and/or residue from dishwashing detergent. For example, the warning could comprise an acoustic signal, for example a signal tone. For example, the household appliance apparatus could have the loudspeaker for outputting the acoustic signal, in particular the signal tone. Alternatively or in addition, the household appliance apparatus could have the buzzer, in particular a piezo buzzer, for outputting the acoustic signal. Furthermore, it would be conceivable that the warning is designed as an optical signal, such as for example a light signal. For example, the household appliance apparatus could have a lighting element, such as for example an LED for outputting the light signal. It is preferred that the warning is designed as a warning message that is displayed in particular on the display. It would be conceivable that the warning comprises a combination of optical and/or visual and/or acoustic signals. In particular, a plurality of differentiated warnings is conceivable in dependence upon the information.

Moreover, it is proposed that the action comprises at least one adaptation of at least one household appliance operating parameter. As a consequence, in particular advantageous characteristics can be achieved with regard to comfort and/or safety. In particular, a correct operation of the household appliance can be ensured. Moreover, due to an embodiment of this type for example it is possible in addition to reduce energy consumption. As a consequence, user satisfaction could be further increased. In particular, the action could comprise at least one adaptation of multiple household appliance operating parameters, in particular an adaptation of a combination of household appliance operating parameters. For example, the household appliance operating parameter could be a cooking parameter. In this regard, it would be conceivable that the household appliance operating parameter is a heating power and/or a heating duration and/or a temperature, in particular a cooking temperature. Alternatively or in addition, it would be conceivable that the household appliance operating parameter is a storage parameter. A storage parameter is to be understood to mean a parameter that influences the food, in particular in the case of storing the food by means of the household appliance. For example, the storage parameter could be a storage temperature and/or an atmosphere and/or a moisture and/or light intensity and/or the like. In particular, the storage parameter could influence the extent of a ripening process and/or a shelf life of the food.

Furthermore, it is proposed that the action comprises at least an adaptation of at least one recipe parameter. In particular, as a consequence it is possible to improve comfort, in particular user comfort. Moreover, it is possible as a consequence to ensure success, in particular recipe success. In particular, it is possible to achieve that a recipe can be adapted to present conditions, in particular to the present state of food. It would be conceivable that the at least one adaptation of the at least one recipe parameter comprises at least one output of a warning to the user, in particular a suggestion for the user to adapt at least one recipe parameter. Likewise, it would be conceivable that the action comprises at least one automatic adaptation of at least one recipe parameter. It would be conceivable that the adaptation of the at least one recipe parameter comprises at least one adaptation of at least one recipe step and advantageously an adaptation of a multiplicity of recipe steps. For example, the adaptation of the at least one recipe parameter could comprise at least one adaptation of at least one sequence of recipe steps. For example, the adaptation of the at least one recipe parameter alternatively or in addition could comprise skipping and/or repeating at least one recipe step. Alternatively or in addition, it would be conceivable that the adaptation of the at least one recipe parameter comprises at least one adaptation, in particular a reduction and/or an extension of a time, advantageously a cooking time, alternatively or in addition a storage time. For example, the adaptation of the at least one recipe parameter alternatively or in addition could comprise at least one adaptation, in particular a reduction and/or an increase of at least one quantity, in particular a quantity, which is provided by a recipe, of one and/or more ingredients. Moreover, it would be conceivable that the adaptation of the at least one recipe parameter alternatively or in addition comprises at least one adaptation, in particular a reduction and/or an increase of a quantity of a spice. Alternatively or in addition, the adaptation of the at least one recipe parameter could comprise at least an addition, in particular an addition of a larger quantity, and/or an omission, in particular at least of a part-quantity, of at least one ingredient. For example, at least the addition, in particular the addition of a larger quantity, and/or the omission, in particular of at least a part-quantity, of at least one ingredient could be provided so as to compensate at least one further ingredient. For example at least one excess of at least one ingredient could be compensated by the adaptation of the at least one recipe parameter.

Moreover, it is proposed that the control unit is provided so as to take into consideration at least one specific item of user information in the operating state and in particular when triggering the action. It is possible due to an embodiment of this type to achieve in particular improved characteristics with regard to comfort, in particular user comfort. In particular, it is possible due to an embodiment of this type to meet requirements of all users. As a consequence, it is possible to improve in particular user-friendliness. Moreover, as a consequence it is possible in particular to optimize a collaborative cooking experience and advantageously to optimize a collaborative cooking result. For example, a plurality of user profiles could be stored on the control unit. Alternatively or in addition, the user profiles could be retrievable by the control unit via the internet, for example in a cable-bound manner and advantageously in a wireless manner. In particular, the at least one specific item of user information is part of one of the user profiles. It is preferred that a multiplicity of specific items of user information is in each case part of one of the user profiles. For example, the specific user information could comprise at least one item of information in relation to at least one allergy, in particular at least one food allergy, of the user. Alternatively or in addition, the specific item of user information could comprise at least one item of information in relation to at least one intolerance, in particular at least one food intolerance, of the user. Alternatively or in addition, the specific item of user information could comprise at least one item of information in relation to recipe parameters that are preferred by the user. Alternatively or in addition, the specific item of user information could comprise at least one item of information in relation to a diet, and namely in particular in relation to foods that are to be avoided by the user.

In order to further render possible in particular comfort and/or safety for the user, moreover a household appliance system is proposed having a household appliance apparatus in accordance with the invention. A household appliance system in this context is to be understood to mean a system for use in a household and/or for use with household objects and the system comprises in particular at least one household function unit. A household function unit is to be understood to mean a unit that in at least one operating state provides at least one household function. In particular, the household function unit can be designed as a part-unit of the household appliance and can be provided for a specific household function of the household appliance in cooperation with other units of the household appliance. Alternatively, the household function unit can be designed as a standalone household appliance. For example, the household appliance apparatus could be distributed to multiple household function units. In particular, the household appliance apparatus could have objects that are installed in different household function units.

Furthermore, a household appliance is proposed having a household appliance apparatus in accordance with the invention. It is consequently possible to achieve in particular a high degree of comfort, in particular user comfort. Advantageously, as a consequence moreover it is possible to achieve a high degree of safety. Moreover, as a consequence in particular it is possible to achieve improved characteristics with regard to an integration of the household appliance apparatus.

Moreover, the invention relates to a method for the operation of a household appliance apparatus, in particular a cooking appliance apparatus, wherein in at least one operating state by means of at least one hyperspectral image capture unit a state, in particular an image, of at least one object is captured in an image capture region and at least one item of information is ascertained based on the state of the at least one object.

The household appliance apparatus, the household appliance having the at least one household appliance apparatus in accordance with the invention, the household appliance system having the at least one household appliance apparatus in accordance with the invention and the method for operating the household appliance apparatus in this case are not to be limited to the above-described application and embodiment. In particular, the household appliance apparatus, the household appliance having the at least one household appliance apparatus in accordance with the invention, the household appliance system having the at least one household appliance apparatus in accordance with the invention and the method for operating the household appliance apparatus in order to fulfil a function that is described herein have a number of individual elements, components, units and method steps that deviate from a number that is mentioned herein.

Further advantages are provided in the following drawing description. Two exemplary embodiments of the invention are illustrated in the drawing. The drawing, the description and the claims include numerous features in combination. The person skilled in the art will also consider the features individually in an expedient manner and combine the features to appropriate further combinations.

In the drawings:

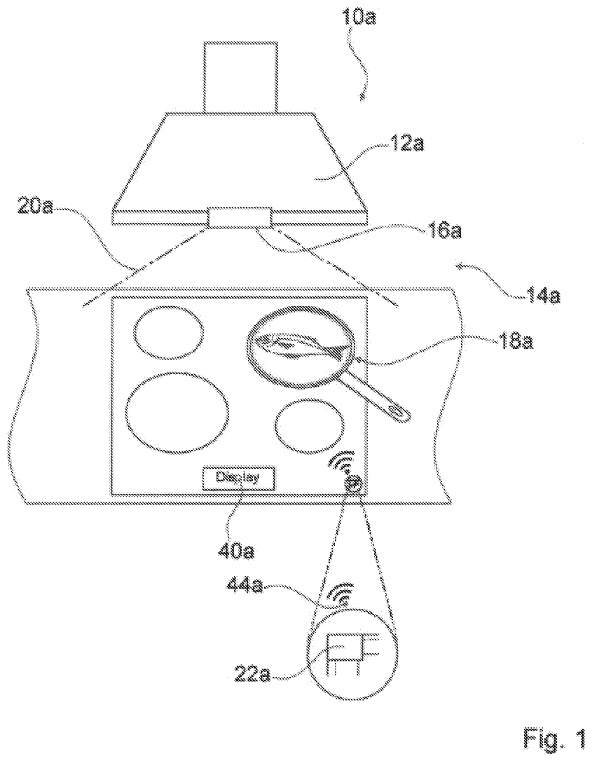

FIG. 1 shows a household appliance system having a household appliance apparatus having a hyperspectral image capture unit in a simplified perspective view,

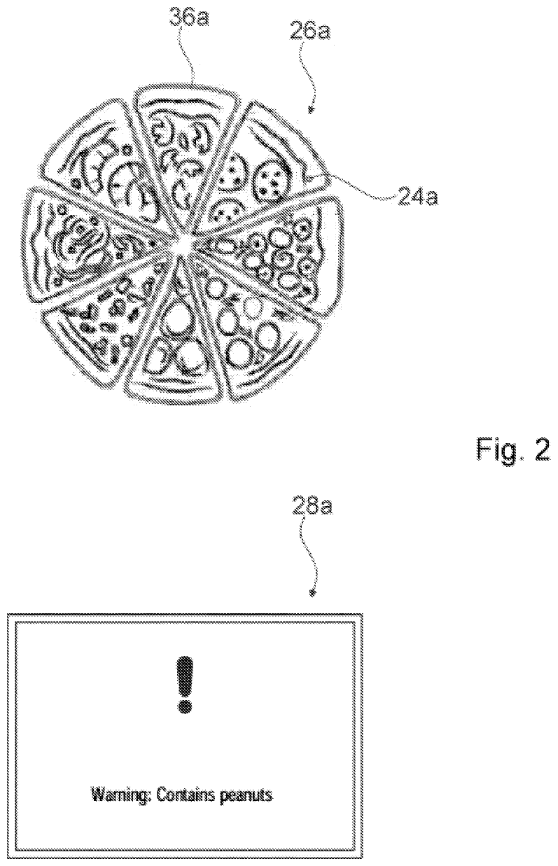

FIG. 2 shows a state of an object that is captured in an operating state by the hyperspectral image capture unit in an image capture region of the hyperspectral image capture unit having a plurality of scanning values,

FIG. 3 shows an output, which is triggered by a control unit of the household appliance apparatus, to a user and the output comprises a warning,

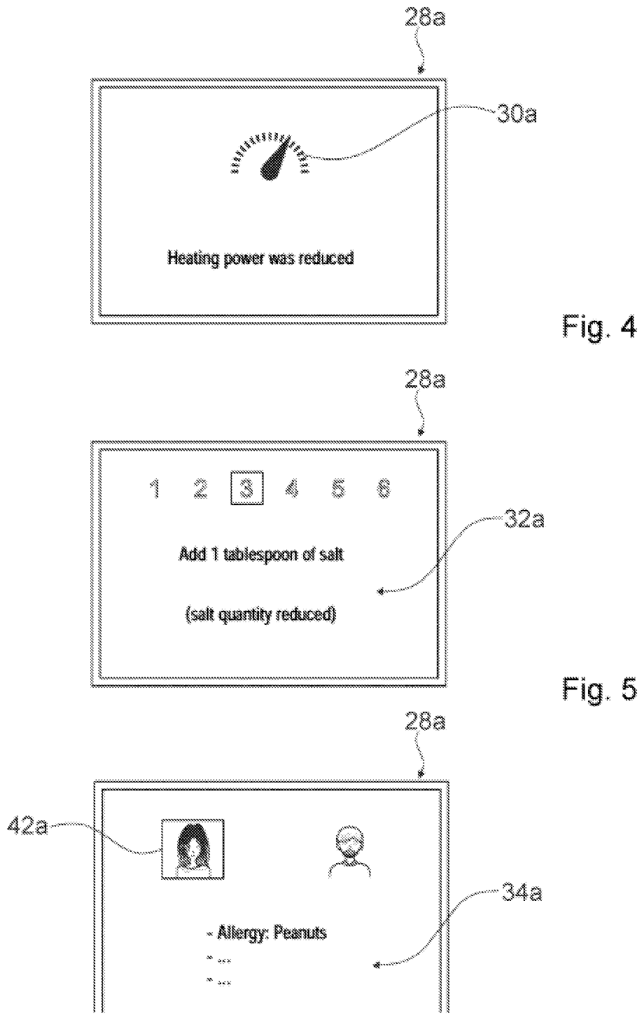

FIG. 4 shows an adaptation, which is triggered by the control unit, of at least one household appliance operating parameter,

FIG. 5 shows an adaptation, which is triggered by the control unit, of at least one recipe parameter,

FIG. 6 shows a specific item of user information that is taken into consideration by the control unit in an operating state,

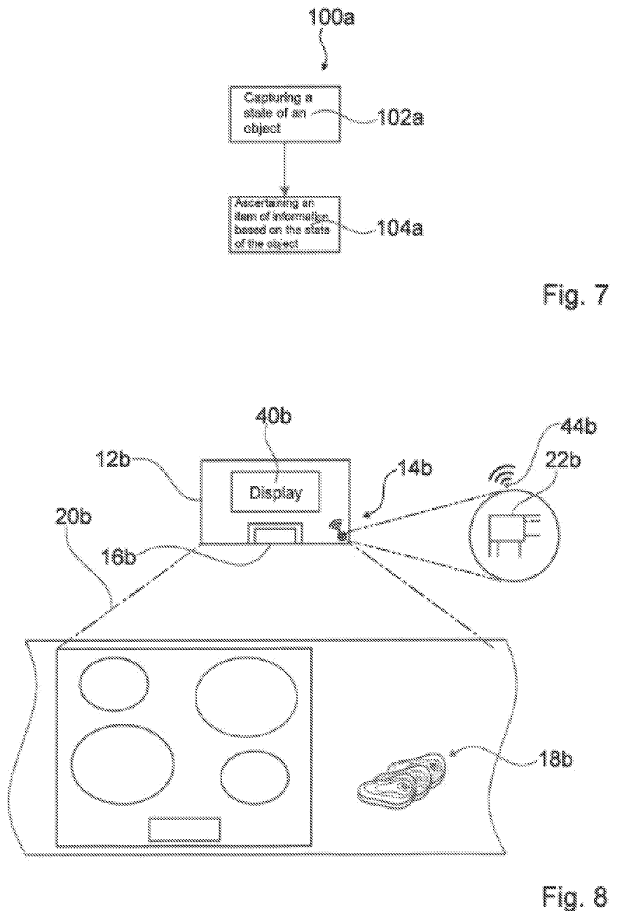

FIG. 7 shows a flow diagram of a method for the operation of the household appliance apparatus having a method step and a further method step and

FIG. 8 shows a further exemplary embodiment of a household appliance apparatus that is part of a household appliance in a simplified perspective view.

In each case, only one of the objects that are provided multiple times in the figures is provided with a reference character.

FIG. 1 illustrates a household appliance system 10a. The household appliance system 10a has a household appliance apparatus 14a. Moreover, the household appliance system 10a has a household appliance 12a that is designed as an extractor hood.

The household appliance apparatus 14a in the illustrated example is designed as a cooking appliance apparatus. The household appliance apparatus 14a is in an operating state.

The household appliance apparatus 14a has a hyperspectral image capture unit 16a. In the illustrated example, the hyperspectral image capture unit 16a is arranged on an extractor hood.

The hyperspectral image capture unit 16a in the illustrated operating state is provided so as to capture a state 36a, in particular an image, of at least one object 18a in an image capture region 20a. The object 18a as an example is designed as a pan and an item of food that is arranged in the pan.

Moreover, the household appliance apparatus 14a has a control unit 22a. The control unit 22a is arranged in particular within a cooking appliance.

The control unit 22a is provided so as in the operating state to ascertain at least one item of information based on the state 36a, in particular based on the image, of the at least one object 18a. The control unit 22a evaluates the state 36a, in particular the image, of the at least one object 18a so as to ascertain the information.

The information comprises at least one item of food-related information and namely in the illustrated example with regard to the food in the pan (cf. FIG. 1 and FIG. 2). Moreover, the information comprises at least one item of information that is not food related and namely in the illustrated example with regard to the pan.

The hyperspectral image capture unit 16a is provided so as to ascertain the state 36a by means of a plurality of scanning values 24a. The plurality of scanning values 24a are illustrated in an exemplary manner with the aid of a plurality of pixels in FIG. 2.

Each scanning value 24a of the plurality of scanning values 24a comprises in each case an item of hyperspectral image information 26a with regard to the object 18a.

In the operating state, the control unit 22a triggers at least one action based on the information. In the illustrated example, the control unit 22a triggers a multiplicity of actions based on the information. The exemplary actions are illustrated in FIGS. 3 to 6.

The actions comprise an output 28a to a user. The output 28a is performed as an example by means of a display 40a of the cooking appliance. FIG. 3 illustrates the output 28a that in the illustrated case comprises a warning. In particular, the information, in particular the food information, is ascertained based on the state 36a that an allergen is contained in the food. In particular, the warning comprises the indication to the user that an allergen is contained in the food.

FIG. 4 illustrates one of the actions that comprises an adaptation of at least one household appliance operating parameter 30a. In the illustrated example, the household appliance operating parameter 30a is designed as a heating power of the cooking appliance. In particular, the control unit 22a triggers a reduction of the heating power of the cooking appliance based on the information.

In the illustrated example, the adaptation of the household appliance operating parameter 30a is displayed with the aid of the display 40a.

FIG. 5 illustrates a further action that comprises an adaptation of a recipe parameter 32a. In particular, the recipe parameter as an example is a quantity of salt that is reduced in the illustrated example, in particular by two units to one unit. In the illustrated example, the adaptation of the recipe parameter 32a is displayed with the aid of the display 40a.

Moreover, the control unit 22a is provided so as to take into consideration at least one specific item of user information 34a in the operating state and in particular when the at least one action is triggered (cf. FIG. 6). The specific item of user information 34a in the illustrated example is designed as information with regard to an allergy and namely a peanut allergy of the user. In particular, in the operating state and in particular when the at least one action is triggered the control unit 22a is provided so as to take into consideration multiple specific items of user information 34a that are part of various user profiles 42a. In the illustrated example, the control unit 22a has a communication unit 44a with which the specific items of user information 34a, in particular the user profiles 42a, can be retrieved. For this purpose, the user can log in using their corresponding user profile 42a, for example using the display 40a.

FIG. 7 illustrates a flow diagram of a method 100a for the operation of the household appliance apparatus 14a. In the illustrated example, the method 100a has a first method step 102a and a further method step 104a.

In the first method step 102a, by means of the hyperspectral image capture unit 16a the state 36a, in particular the image, of the object 18a is captured in the image capture region 20a and namely if the household appliance apparatus is in the operating state.

In the further method step 104a, the information is ascertained based on the state 36a of the object 18a and namely in particular automatically.

A further exemplary embodiment of the invention is illustrated in FIG. 8. The following descriptions are limited essentially to the differences between the exemplary embodiments, wherein in relation to components, features and functions that remain identical, reference is made to the description of the exemplary embodiment of FIGS. 1 to 7. In order to differentiate the exemplary embodiments, the letter a is replaced in the reference characters of the exemplary embodiment in FIGS. 1 to 7 by the letter b in the reference characters of the exemplary embodiment of FIG. 8. In relation to components that remain identical, in particular in relation to components having identical reference characters, it is possible fundamentally also to refer to the drawings and/or the description of the exemplary embodiment of FIGS. 1 to 7.

FIG. 8 illustrates a further exemplary embodiment of the invention and namely a household appliance 12b having a further household appliance apparatus 14b.

The household appliance 12b is designed as a wall module and in the illustrated example is mounted on a wall. The household appliance 12b in the illustrated example comprises all the components of the household appliance apparatus 14b.

The household appliance apparatus 14b has a hyperspectral image capture unit 16b. The hyperspectral image capture unit 16b has an image capture region 20b which covers at least a region on a worktop. Furthermore, the image capture region 20b covers a hob. The household appliance apparatus 14b has a display 40b for outputting information.

### REFERENCE CHARACTERS

10 Household appliance system
12 Household appliance
14 Household appliance apparatus
16 Hyperspectral image capture unit
18 Object
20 Image capture region
22 Control unit
24 Scanning value
26 Hyperspectral image information
28 Output
30 Household appliance operating parameter
32 Recipe parameter
34 Specific user information
36 State
40 Display
42 User profile
44 Communication unit
100 Method
102 Method step
104 Further method step

1.-13. (canceled)

14. A household appliance apparatus, comprising:
a hyperspectral image capture unit configured to capture in an operating state a state of an object in an image capture region; and
a control unit configured to ascertain an item of information in the operating state based on the state of the one object.

15. The household appliance apparatus of claim 14, embodied as a cooking appliance apparatus.

16. The household appliance apparatus of claim 14, wherein the hyperspectral image capture unit is configured to capture the state by using a plurality of scanning values which comprise each an item of hyperspectral image information with regard to the object.

17. The household appliance apparatus of claim 14, wherein the item of information comprises an item of food-related information.

18. The household appliance apparatus of claim 14, wherein the item of information comprises an item of information that is not food related.

19. The household appliance apparatus of claim 14, wherein the control unit is configured to trigger in the operating state an action based on the item of information.

20. The household appliance apparatus of claim 19, wherein the action comprises an output to a user.

21. The household appliance apparatus of claim 20, wherein the output comprises a warning.

22. The household appliance apparatus of claim 19, wherein the action comprises an adaptation of a household appliance operating parameter.

23. The household appliance apparatus of claim 19, wherein the action comprises an adaptation of a recipe parameter.

24. The household appliance apparatus of claim 14, wherein the control unit is configured to take into consideration a specific item of user information in the operating state.

25. A household appliance system, comprising a household appliance apparatus, said household appliance apparatus comprising a hyperspectral image capture unit configured to capture in an operating state a state of an object in an image capture region, and a control unit configured to ascertain an item of information in the operating state based on the state of the one object.

26. A household appliance, comprising a household appliance apparatus as set forth in claim 14.

27. A method for operating a household appliance apparatus, said method comprising:
capturing in an operating state with a hyperspectral image capture unit a state of an object in an image capture region; and
ascertaining an item of information based on the state of the object.

28. The method of claim 27 for operating a cooking appliance apparatus as the household appliance apparatus.

29. The method of claim 27, wherein the state of the object is captured by using a plurality of scanning values which comprise each an item of hyperspectral image information with regard to the object.

30. The method of claim 27, further comprising triggering in the operating state an action based on the item of information.

31. The method of claim 30, wherein the action comprises an output to a user.

32. The method of claim 31, wherein the output comprises a warning.

33. The method of claim 30, wherein the action comprises an adaptation of a household appliance operating parameter.
